(19) United States
(12) Patent Application Publication
(10) Pub. No.: US 2026/0318114 A1
(43) Pub. Date: Oct. 15, 2026

(54) Bolt Lock

(71) Applicant: Shanghai Shanmai Electronic Technology Development Co., Ltd., Shanghai (CN)

(72) Inventor: Yongbin Zhang, Shanghai (CN)

(73) Assignee: Shanghai Shanmai Electronic Technology Development Co., Ltd., Shanghai (CN)

(21) Appl. No.: 18/998,848

(22) PCT Filed: Oct. 11, 2023
(86) PCT No.: PCT/CN2023/124016

§ 371 Date: Jan. 27, 2025

(30) Foreign Application Priority Data
Nov. 24, 2022 (CN) 202223126644.4

(51) Int. Cl. E05B 47/00

(52) U.S. Cl. CPC E05B 47/0004; E05B 2047/0016; E05B 2047/0018; E05B 2047/0035; E05B 2047/0076

(57) ABSTRACT

A bolt lock, comprising: a lock body (1); a bolt (2), which is slidably mounted in the lock body (1) and is provided with a locking face (21); a drive assembly (3), which is mounted in the lock body (1) and comprises a drive member (31) in transmission connection with the bolt (2); an electric drive mechanism (4), which is mounted in the lock body (1) and drives the bolt (2) to extend out or retract into the lock body (1) via the drive assembly (3); wherein, in a locked state, the bolt (2) extends out of the lock body (1), and the drive member (31) abuts against the locking face (21) so as to provide an abutting force for preventing the bolt (2) from retracting into the lock body (1).

### CROSS REFERENCE TO RELATED APPLICATIONS

This application claims priority to Chinese Patent Application No. 202223126644.4, titled “Bolt Lock”, filed on Nov. 24, 2022 with the China National Intellectual Property Administration, the entire contents of which are incorporated herein by reference.

### TECHNICAL FIELD

The application relates to a lock structure, particularly to a bolt lock.

### BACKGROUND

A bolt lock typically comprises a bolt and a lock buckle plate with a hole, where the insertion of the bolt into the hole of the lock buckle plate indicates a locked state. Existing bolt locks include electrically actuated bolt locks, which generally use an electromagnet (solenoid) as a power source, utilizing magnetism when energized and demagnetization when power is cut off, thus achieving the process of the bolt entering or exiting the hole in the lock buckle plate. However, once a power failure occurs, the electrically actuated bolt lock becomes largely ineffective, and thieves can use thin pieces inserted into door gaps to gradually manipulate the bolt to unlock, enabling theft. As such, during power outages, the bolt of an electrically actuated bolt lock can be easily manipulated, leading to poor anti-theft performance.

### SUMMARY

The objective of the application is to provide a bolt lock that enhances the anti-theft performance of the bolt lock.

To achieve the above objective, the application proposes a bolt lock, comprising:
a lock body;
a bolt which is slidably mounted the lock body and is provided with a locking face;
a drive assembly which is mounted in the lock body and comprises a drive member in transmission connection with the bolt;
an electric drive mechanism, which is mounted in the lock body and drives the bolt to extend out or retract into the lock body via the drive member;
wherein, in a locked state, the bolt extends out of the lock body, and the drive member abuts against the locking face to provide a abutting force for preventing the bolt from retracting into the lock body.

In one or more embodiments, the drive member comprises a drive portion which can abut against the locking face to provide an abutting force for preventing the bolt from retracting into the lock body.

In one or more embodiments, the drive member is rotationally connected within the lock body, the axial direction of the drive portion passes through the rotational center of the drive member; in the locked state, the axial direction of the drive portion is perpendicular to the locking face, and not perpendicular to the direction in which the bolt extends or retracts.

In one or more embodiments, the drive assembly further comprises a transmission member, and the drive member is connected to the electric drive mechanism via the transmission member.

In one or more embodiments, the electric drive mechanism comprises a solenoid and a core shaft, one end of the transmission element is rotationally connected to the core shaft while the other end is rotationally connected to the drive member; and in the energized state, the solenoid generates magnetic force and drives the core shaft to move axially, and the core shaft drives the drive member to rotate via the transmission member, thereby driving the bolt to extend out or retract into the lock body.

In one or more embodiments, the core shaft is sleeved with a return spring which is configured to drive the core shaft back to an original position in the power-off state, thus achieving the switching between the extension and retraction of the bolt within the lock body.

In one or more embodiments, the core shaft is provided with a first accommodation groove, one end of the transmission member is rotationally connected to the first accommodation groove; and/or,
the drive member is provided with a second accommodation groove, and the other end of the transmission member is rotationally connected to the second accommodation groove.

In one or more embodiments, the bolt comprises an unlocking face, and in the unlocked state, the drive portion abuts against the unlocking face to drive the bolt to retract into the lock body.

In one or more embodiments, the lock body is provided with a limit groove, the extension direction of the limit groove is the same as the extension and retraction direction of the bolt, the bolt is provided with a limit block, and the limit block is slidably connected within the limit groove.

In one or more embodiments, the bolt lock further comprises a lock buckle plate, the lock buckle plate has a lock hole; and in the locked state, the bolt extends out of the lock body and inserts into the lock hole.

Compared to the prior art, according to the bolt lock of the disclosure, a drive member is provided in the lock body, and in the locked state, the drive member abuts against the locking face, providing a abutting force or preventing the bolt from retracting into the lock body. Such an arrangement allows the bolt lock to remain in a locked state even when encountering power failures, i.e., the bolt is difficult to be manipulated by thin pieces inserted into gaps, enhancing the anti-theft performance of the bolt lock.

### BRIEF DESCRIPTION OF THE DRAWINGS

FIG. 1 is a cross-sectional view of the bolt lock in the locked state according to one embodiment of the disclosure;

FIG. 2 is a cross-sectional view of the bolt lock in the unlocked state according to one embodiment of the disclosure;

FIG. 3 is a schematic diagram of the connection between the drive assembly and the electric drive mechanism according to one embodiment of the disclosure;

FIG. 4 is a cross-sectional view of the bolt lock in the locked state according to another embodiment of the disclosure.

Explanation of main drawing reference signs:

1—lock body; 11—limit groove; 2—bolt; 21—locking face; 22—unlocking face; 23—limit block; 3—drive assembly; 31—drive member; 311—drive portion; 312—second accommodation groove; 32—transmission member; 4—electric drive mechanism; 41—solenoid; 42—core shaft; 421—first accommodation groove; 422—return spring; 5—lock buckle plate; 51—lock hole.

### DETAILED DESCRIPTION

The specific embodiments will be described in detail in conjunction with the drawings, but it should be understood that the scope of protection of the application is not limited by the specific embodiments.

Unless otherwise explicitly stated, throughout the specification and claims, terms such as “comprise” or their variations such as “include” or “have” shall be understood to include the stated elements or components and not exclude other elements or components.

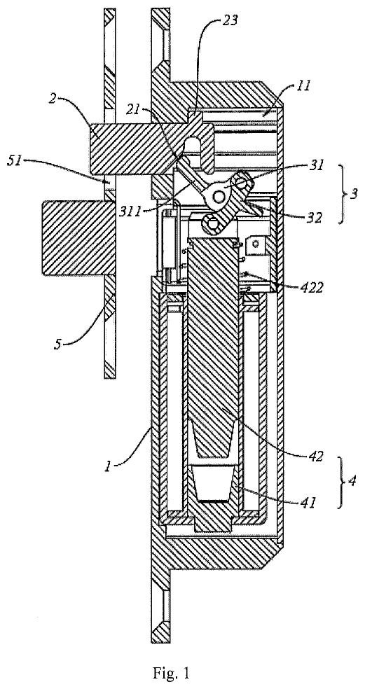

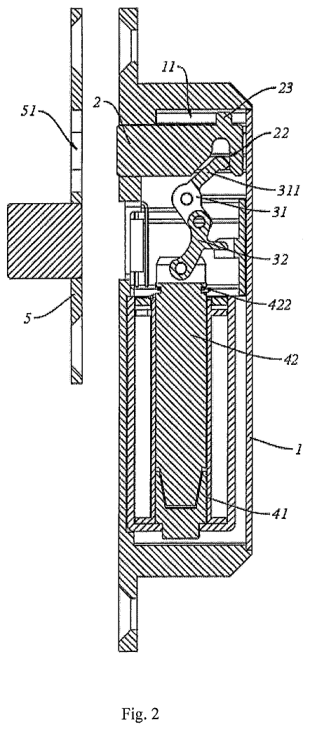

As shown in FIGS. 1 and 2, the bolt lock according to an embodiment of the application comprises a lock body 1, a bolt 2, a drive assembly 3, and an electric drive mechanism 4. The bolt 2 is slidably mounted in the lock body 1, and the bolt 2 has a locking face 21. The drive assembly 3 is mounted in the lock body 1, and the drive assembly 3 comprises a drive member 31 in transmission connection with the bolt 2. The electric drive mechanism 4 is mounted in the lock body 1, and drives the bolt 2 to extend out or retract into the lock body 1 via the drive assembly 3. In the locked state, the bolt 2 extends out of the lock body 1, the drive member 31 abuts against the locking face 21 to provide an abutting force for preventing the bolt 2 from retracting into the lock body 1.

It can be understood that, in addition to driving the bolt 2 to extend out of the lock body 1 and play a locking role (locked state) in the application, in the locked state, the drive member 31 also abuts against the locking face 21 to provide a abutting force for preventing the bolt 2 from retracting into the lock body 1, thus making it impossible for the outside world to simply manipulate the bolt 2 with other tools (such as thin pieces) from the gap, causing it to retract into the lock body 1, thereby enhancing the anti-theft performance of the bolt lock.

In a specific embodiment, the bolt lock further comprises a lock buckle plate 5, the lock buckle plate 5 has a lock hole 51, and in the locked state, the bolt 2 extends out of the lock body 1 and inserts into the lock hole 51. As shown, the aforementioned gap can be understood as the space between the lock buckle plate 5 and the lock body 1.

Generally, the lock buckle plate 5 and the lock body 1 are respectively mounted on two cooperating objects so that the bolt lock can lock the two objects. For example, the two cooperating objects can be a door and a door frame, a window and a window frame, a cabinet door and a cabinet body, etc.

In a specific embodiment, the drive member 31 comprises a drive portion 311, and the drive portion 311 can abut against the locking face 21 to provide an abutting force for preventing the bolt 2 from retracting into the lock body 1. As shown, the drive portion 311 can be rod-shaped.

Specifically, the drive member 31 is rotationally connected in the lock body 1, the axial direction of the drive portion 311 passes through the rotational center of the drive member 31, and in the locked state, the axial direction of the drive portion 311 is perpendicular to the locking face 21 and not perpendicular to the extension and retraction direction of the bolt 2. Such a configuration ensures that when the bolt 2 retracts into the lock body 1, the thrust given by the bolt 2 via the locking face 21 to the drive portion 311 is in the same direction as the axial direction of the drive portion 311. Because the axial direction of the drive portion 311 passes through the rotational center of the drive member 31, this thrust cannot cause the drive member 31 to rotate, thus the bolt 2 cannot retract into the lock body 1.

Further, the drive assembly 3 also comprises a transmission member 32, and the drive member 31 is connected to the electric drive mechanism 4 via the transmission member 32.

Specifically, the electric drive mechanism 4 comprises a solenoid 41 and a core shaft 42, one end of the transmission member 32 is rotationally connected to the core shaft 42, and the other end of the transmission member 32 is rotationally connected to the drive member 31. In the energized state, the solenoid 41 generates a magnetic force and drives the core shaft 42 to move axially, and the core shaft 42 drives the drive member 31 to rotate via the transmission member 32, thereby driving the bolt 2 to extend or retract from the lock body 1. The transmission member 32 can convert the linear force produced by the electric drive mechanism 4 into a force that causes the drive member 31 to rotate.

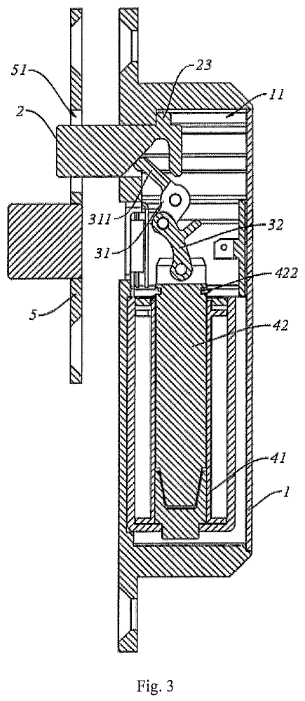

As shown in FIG. 3, further, the core shaft 42 is provided with a first accommodation groove 421, one end of the transmission member 32 is rotationally connected to the first accommodation groove 421; and/or, the drive member 31 is provided with a second accommodation groove 312, the other end of the transmission member 32 is rotationally connected to the second accommodation groove 312. Such a configuration can strengthen the connection between the transmission member 32 and the core shaft 42 as well as the drive member 31, while the first accommodation groove 421 and the second accommodation groove 312 can also play a role in avoiding the collision during the movement of the transmission member 32.

In a specific embodiment, the core shaft 42 is sleeved with a return spring 422 which is used to drive the core haft 42 back to an original position in the power-off state, thus achieving the switching between the extension and retraction of the bolt 2 in the lock body 1. Specifically, as shown in FIG. 2, in the energized state, the return spring 422 is in a compressed state, and at this time the bolt 2 retracts into the lock body 1, which can be considered as the bolt lock being in an unlocked state. As shown in FIG. 1, in the power-off state, the return spring 422 that is in a compressed state will return, thus driving the core shaft 42 to move upward, so that the drive member 31 pushes the bolt 2 to extend out of the lock body 1, which can be considered as the bolt lock being in a locked state.

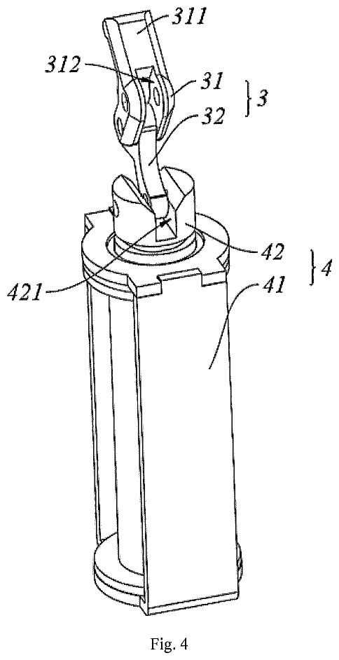

As shown in FIG. 4, in other embodiments, only minor adjustments need to be made to the drive assembly 3, so that in the energized state, the return spring 422 is in a compressed state. At this time the bolt 2 extends out of the lock body 1, which can be considered as the bolt lock being in a locked state. In the power-off state (the figure for this state is not shown), the bolt 2 retracts into the lock body 1, which can be considered as the bolt lock being in an unlocked state.

As shown in FIG. 2, in a specific embodiment, the bolt 2 has an unlocking face 22, and in the unlocked state, the drive portion 311 abuts against the unlocking face 22 to drive the bolt 2 to retract into the lock body 1.

As shown in FIGS. 1 and 2, in one or more embodiments, the lock body 1 is provided with a limit groove 11. The extension direction of the limit groove 11 is the same as the extension and retraction direction of the bolt 2. The bolt 2 is provided with a limit block 23, and the limit block 23 is slidably connected within the limit groove 11. The cooperation between the limit groove 11 and the limit block 23 can play a positioning role when mounting the bolt 2 in the lock body 1, and can also play a guiding and limiting role when the bolt 2 extends out or retracts into the lock body 1.

Summarizing the above, the advantages of the bolt lock in the disclosure are:
1) the bolt lock has excellent anti-theft performance, therefore the bolt lock can be applied in anti-theft fields such as furniture, anti-theft doors, cabinets, etc.
2) this structure of the bolt lock can achieve power-on locking or power-off locking by replacing the drive assembly, power-off locking can further enhance the anti-theft performance of the product, i.e., when there is a power outage, the product maintains a locked state.
3) the bolt lock facilitates installation and construction, and more user-friendly installation positions can be chosen.

The foregoing descriptions of specific exemplary embodiments of the application have been provided for the purposes of illustration and exemplification. These descriptions are not intended to limit the application to the precise forms disclosed, and obviously, many modifications and variations can be made based on the above teachings. The selection and description of exemplary embodiments are intended to explain the principles of the application and their practical applications, thereby enabling those skilled in the art to implement and utilize various different exemplary embodiments of the application and various options and changes. The scope of the application is intended to be defined by the claims and their equivalents.

What is claimed is:

1. A bolt lock comprising:
a lock body;
a bolt slidably mounted in the lock body, the bolt having a locking face;
a drive assembly, which is mounted in the lock body and comprises a drive member in transmission connection with the bolt;
an electric drive mechanism which is mounted in the lock body and drives the bolt to extend out or retract into the lock body via the drive assembly;
wherein, in a locked state, the bolt extends out of the lock body, and the drive member abuts against the locking face to provide an abutting force for preventing the bolt from retracting into the lock body.

2. The bolt lock according to claim 1, wherein the drive member comprises a drive portion that, in the locked state, abuts against the locking face to provide the abutting force for preventing the bolt from retracting into the lock body.

3. The bolt lock according to claim 2, wherein the drive member is rotationally connected in the lock body, an axial direction of the drive portion passes through a rotational center of the drive member, and in the locked state, the axial direction of the drive portion is perpendicular to the locking face and not perpendicular to an extension and retraction direction of the bolt.

4. The bolt lock according to claim 3, wherein the drive assembly further comprises a transmission member, and the drive member is connected to the electric drive mechanism via the transmission member.

5. The bolt lock according to claim 4, wherein the electric drive mechanism comprises a solenoid and a core shaft, one end of the transmission member is rotationally connected to the core shaft and the other end of the transmission member is rotationally connected to the drive member, and, in an energized state, the solenoid generates magnetic force and drives the core shaft to move axially, and the core shaft drives the drive member to rotate via the transmission member, thereby driving the bolt to extend out or retract into the lock body.

6. The bolt lock according to claim 5, wherein the core shaft is sleeved with a return spring that is configured to drive the core shaft back to an original position in the power-off state, thus achieving switching between the extension and retraction of the bolt in the lock body.

7. The bolt lock according to claim 5, wherein the core shaft is provided with a first accommodation groove, one end of the transmission member is rotationally connected to the first accommodation groove; and/or,
the drive member is provided with a second accommodation groove, the other end of the transmission member is rotationally connected to the second accommodation groove.

8. The bolt lock according to claim 2, wherein the bolt comprises an unlocking face, and in the unlocked state, the drive portion abuts against the unlocking face to drive the bolt to retract into the lock body.

9. The bolt lock according to claim 1, wherein the lock body is provided with a limit groove, an extension direction of the limit groove is the same as the extension and retraction direction of the bolt, the bolt is provided with a limit block, and the limit block is slidably connected in the limit groove.

10. The bolt lock according to claim 1, wherein the bolt lock further comprises a lock buckle plate, the lock buckle plate has a lock hole, and in the locked state, the bolt extends out of the lock body and inserts into the lock hole.
